(19) United States
(12) Patent Application Publication
(10) Pub. No.: US 2019/0362372 A1
(43) Pub. Date: Nov. 28, 2019

(54) MEMBER VALUE MANAGEMENT METHOD

(71) Applicants: Yu-Hsin Wei, Taipei City (TW); Ping-Hsien Chou, Taipei City (TW)

(72) Inventors: Yu-Hsin Wei, Taipei City (TW); Ping-Hsien Chou, Taipei City (TW)

(21) Appl. No.: 15/986,211

(22) Filed: May 22, 2018

(51) Int. Cl. G06Q 30/02; G06Q 20/32; G06K 19/06; G06Q 10/10; H04L 12/58

(52) U.S. Cl. CPC G06Q 30/0215; G06Q 20/322; H04L 51/04; G06Q 10/107; G06K 19/06037

(57) ABSTRACT

A member value management method is provided, including following steps of: through an instant messenger (IM) on a user end device, joining a business IM group with an IM account of the user end device; a chatbot application programming interface (API) of the business IM group generating an identification (ID) which corresponds to the IM account, saving the ID to a member host, and assigning the ID to the user end device through the business IM group, each said ID generated by the chatbot API being exclusive and unique, the ID being different from the IM account; an information obtaining device at a point of sale obtaining a member-associated information which includes the ID and sending the member-associated information to the member host, the member host managing a member value corresponding to the ID based on the member-associated information.

### BACKGROUND OF THE INVENTION

### Field of the Invention

The present invention relates to a member value management method.

### Description of the Prior Art

There are many common member value management methods: 1. giving and deducting credits with a paper loyalty card; 2. a consumer downloads an app developed by a business to his/her mobile phone and uses a credit recording feature in the app; 3. using a tablet customization program and adding a tablet and a specific app at the counter, let the consumer to enter his/her phone number on an Android tablet to identify and add and deduct credits; 4. brands and businesses cooperate with banks to issue co-branded chip cards, using a chip card and an electronic card reader to top up and to add and deduct credits; 5. building a simple credit giving feature in an instant messenger for businesses to use; 6. a credit collecting feature of a self-owned member system.

However, the above-mentioned systems have disadvantages as follows: for types 4 and 6, the consumer needs to apply with personal information, the businesses needs to spend on the chip cards and equipments, and it is inconvenient to carry and show the chip cards; for types 1, 3 and 5, it is difficult to do electronic analysis combining sale data; for types 2 and 3, the consumer is required to install the app or provide his/her phone number so it is hard to increase a use rate; for types 1, 3 and 5, there are issues of fake credits; and except for type 5, the other types are unable to combine and manage offline real consumers and the instant messenger (IM) groups of the online businesses.

In the application field of existing chatbot, there is a B2C method for credit (or anything with business value) interaction between physical store(s) and daily end consumers during the trading process, so it is hard to transfer offline consumers to online IM members. In a common IM, the ID QR code of a personal account is a short URL, for example, when scanning the personal ID QR code of Line, it may show as http://line.me/ti/p/U7Cpez6w6e, and the personal ID needs to be identified and used through an IM official host. However, in order to protect end user privacy and abusing, the IM does not allow any exterior device to read, identify and directly use IM's ID QR code of a personal account, so the IM's ID QR code of a personal account shown as a short URL are not unique and usable.

The chatbot feature has been widely used, and the user end can chat and interact with the host through artificial intelligence technology. The chatbot feature is used by business account users on many instant messenger interfaces to serve consumers (C2B) online and response to the needs of business partners (B2B) instantly. Nevertheless, under the consideration of protecting end user privacy, IM restricts offline business users from reading and using end user's personal ID, so it is difficult for the businesses of IM to combine offline consumers and IM online members.

The present invention has arisen to mitigate and/or obviate the afore-described disadvantages.

### SUMMARY OF THE INVENTION

The major object of the present invention is to provide a member value management method which can be used to manage offline consumers and online instant messenger members.

To achieve the above and other objects, a member value management method is provided, including following steps of: through an instant messenger (IM) on a user end device, joining a business IM group with an IM account of the user end device; a chatbot application programming interface (API) of the business IM group generating an identification (ID) which corresponds to the IM account, saving the ID to a member host, and assigning the ID to the user end device through the business IM group, each said ID generated by the chatbot API being exclusive and unique, the ID being different from the IM account; an information obtaining device of a point of sale (POS) obtaining a member-associated information which includes the ID and sending the member-associated information to the member host, the member host managing a member value corresponding to the ID based on the member-associated information.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a diagram showing a structural relation of a member value management system of a first preferred embodiment of the present invention;

FIG. 2 is a flow chart showing a user end device showing identification of the first preferred embodiment of the present invention;

FIG. 3 is a flow chart showing a member value variation of the first preferred embodiment of the present invention;

FIG. 4 is a flow chart showing a process of checking member value of the first preferred embodiment of the present invention;

FIG. 5 is a diagram showing the structural relation of the member value management system of a second preferred embodiment of the present invention;

FIG. 6 is a flow chart showing the member value variation of the second preferred embodiment of the present invention;

FIG. 7 is a diagram showing the structural relation of the member value management system of a third preferred embodiment of the present invention;

FIG. 8 is a flow chart showing the member value variation of the third preferred embodiment of the present invention;

FIG. 9 is a diagram showing the structural relation of the member value management system of a fourth preferred embodiment of the present invention;

FIG. 10 is a flow chart showing a process of matching member identities of two member systems of the fourth preferred embodiment of the present invention;

FIG. 11 is a flow chart showing the member value variation of the fourth preferred embodiment of the present invention; and

FIG. 12 is a flow chart showing the process of checking member value of the fourth preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

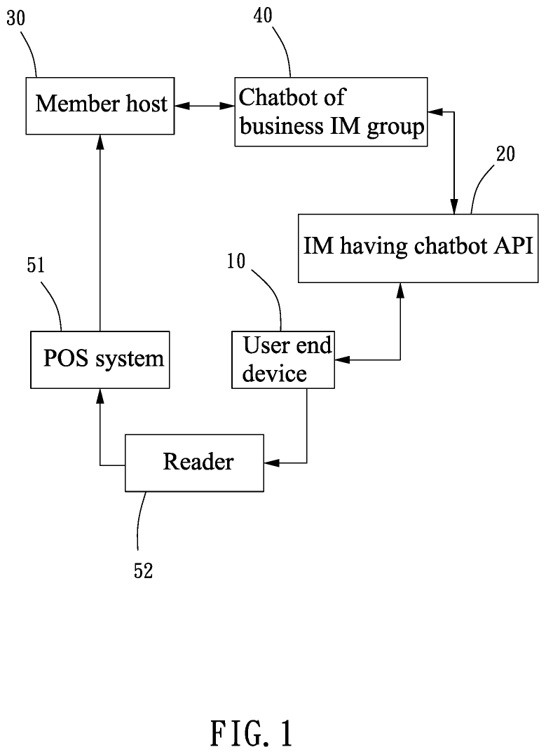

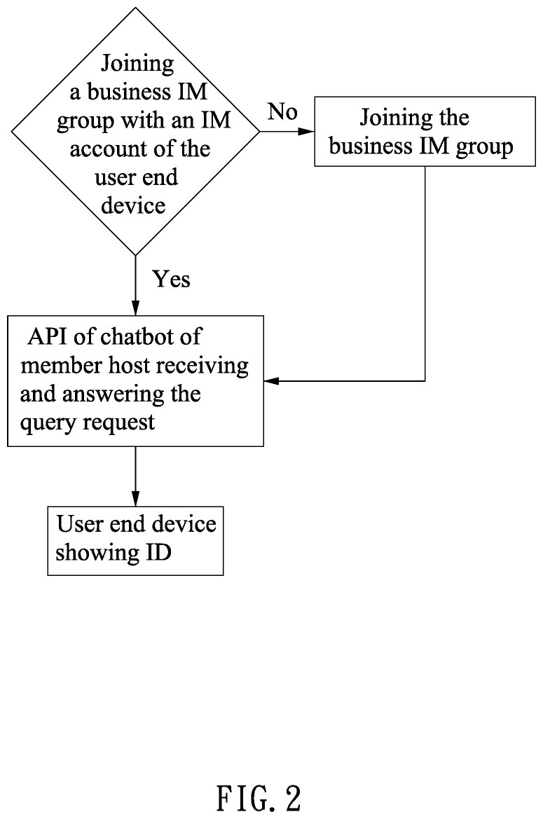

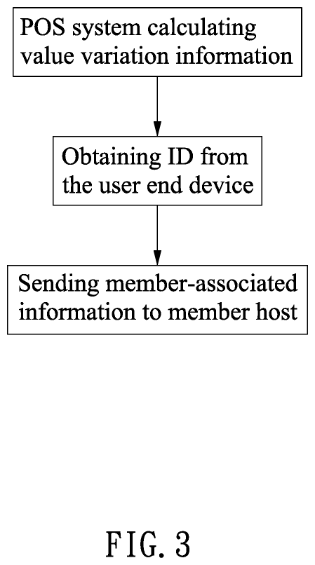

Please refer to FIGS. 1 to 4 for a first preferred embodiment of a member value management method of the present invention. The member value management method includes following steps of: through an instant messenger (IM) 20 on a user end device 10, joining a business IM group with an IM account of the user end device 10, and saving the IM account to a member host 30; a chatbot application programming interface (API) 40 of the business IM group generating an identification (ID) which corresponds to the IM account, saving the ID to the member host 30, and assigning the ID to the user end device 10 through the business IM group, each said ID generated by the chatbot API being exclusive and unique, the ID being different from the IM account; an information obtaining device of a point of sale obtaining a member-associated information which includes the ID and sending the member-associated information to the member host 30, the member host 30 managing a member value (credits, amounts or other similar alternatives) corresponding to the ID based on the member-associated information. In the business IM group, all IDs which correspond to all IM accounts are exclusive and unique. The point of sale may be an offline physical store or an online store. Therefore, the member value management method combines the management of offline consumers and online IM members, including member value variation, checking or maintenance of related information.

The user end device 10 may be, for example, a mobile phone, a tablet or other mobile communication devices, and the instant messenger 20 includes but limited to Line, Facebook, WeChat, WhatsApp, or any instant messenger having a chatbot API. The ID is a 2D barcode generated based on a code, the code is a string (0364364a-b821-4d54-adaa-bc1d8c274417), and the 2D barcode may be a QR code. However, the ID may be in other forms. In this embodiment, the chatbot API 40 of the business IM group generates the code base on the IM account and generates the 2D barcode based on the code to be the ID.

The information obtaining device includes a point of sale (POS) system 51 which is in communication with the member host 30 and a reader 52 (for example, a barcode scanner) which is connected to the POS system 51. If the IM account of the user end device 10 has not been added to the business IM group, the IM account needs to be added into the business IM group and obtain the ID, when a consumer purchases items in a physical store, the POS system 51 calculates a value variation information (credits, amounts or other similar alternatives) based on an expense value, the reader 52 obtains the ID (for example, a QR code) of the user end device 10, the POS system 51 matches the ID of the user end device 10 and the value variation information and sends to the member host 30 for recording and updating the member value.

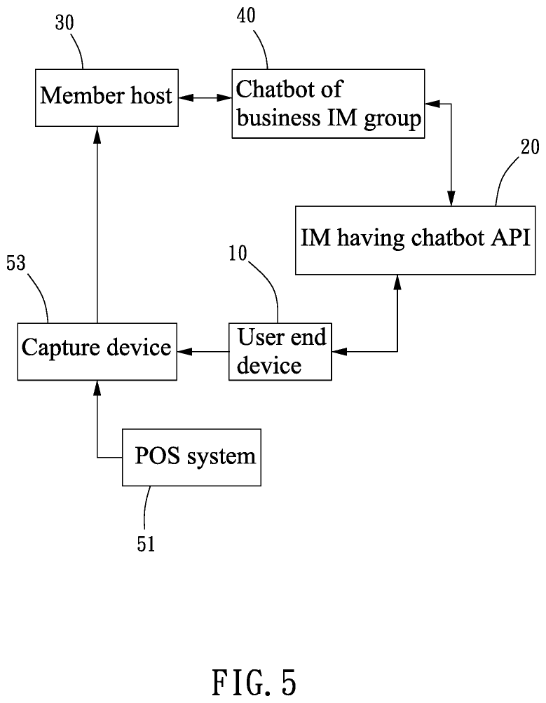

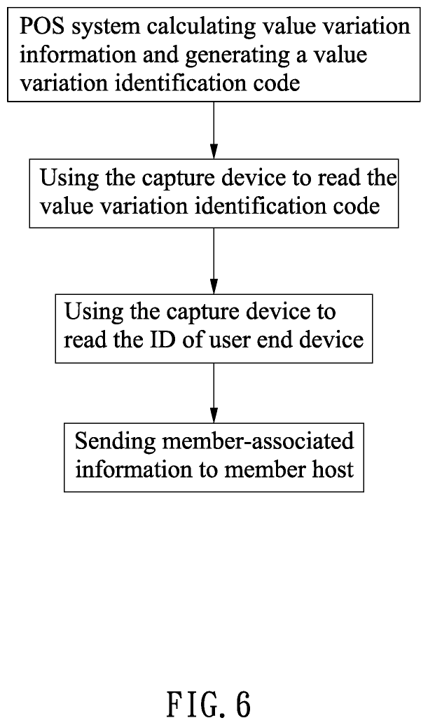

In a second preferred embodiment of FIGS. 5 and 6, the information obtaining device is a capture device 53 which is communicable with the member host 30 and has a video capturing feature (for example, a mobile, a tablet or a laptop which has the features of taking photos and connecting to the internet), the POS system 51 (may also be in communication with the member host 30) calculates the value variation information based on the expense value and generates a value variation identification code (for example, a QR code) based on the value variation information, the value variation identification code can be shown on a point of sale screen or printed on a paper. The capture device 53 reads the value variation identification code and the ID of the user end device 10 via a dedicated software, and the capture device 53 matches the ID of the user end device 10 with the value variation information which corresponds to the value variation identification code and sends to the member host 30 for recording and updating the member value.

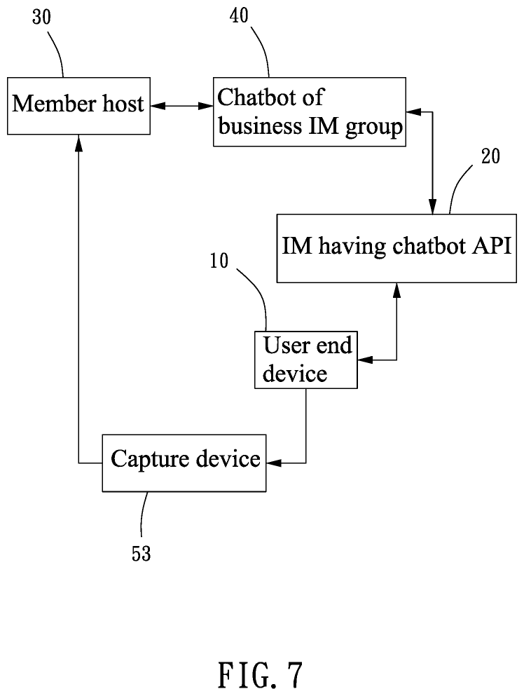

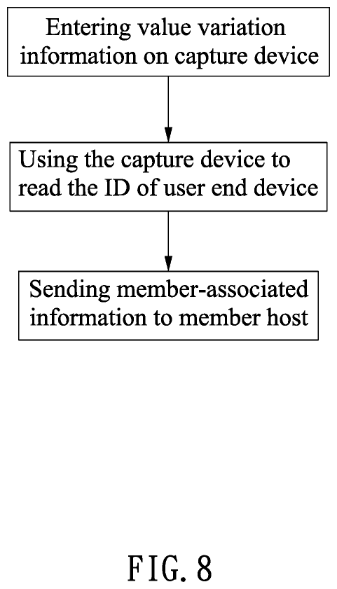

In a third preferred embodiment of FIGS. 7 and 8, the information obtaining device is the capture device 53 which is communicable with the member host 30 and has the video capturing feature. When there is no POS system, the value variation information (for example, a cashier enters a credit variation in a dedicated app on the capture device 53) is entered on the capture device 53 (for example, a mobile, a tablet or a laptop which has the features of taking photos and connecting to the internet) based on the expense value, the capture device 53 reads the ID of the user end device 10, and the capture device 53 matches the ID of the user end device 10 with the value variation information and sends to the member host for recording and updating the member value.

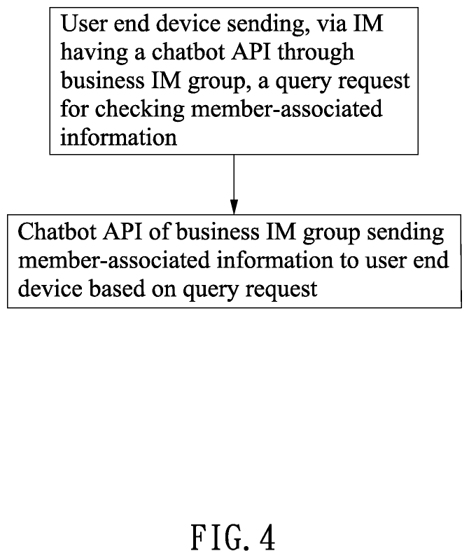

In the first to third preferred embodiments mentioned above, the member value management method further includes following steps of: the user end device 10 sending, via the IM having the chatbot API 40 through the business IM group, a query request for checking the member-associated information, the chatbot API 40 of the business IM group sending the member-associated information to the user end device 10 based on the query request, as shown in FIG. 4, the member-associated information being a member value variation generated based on trading at the point of sale.

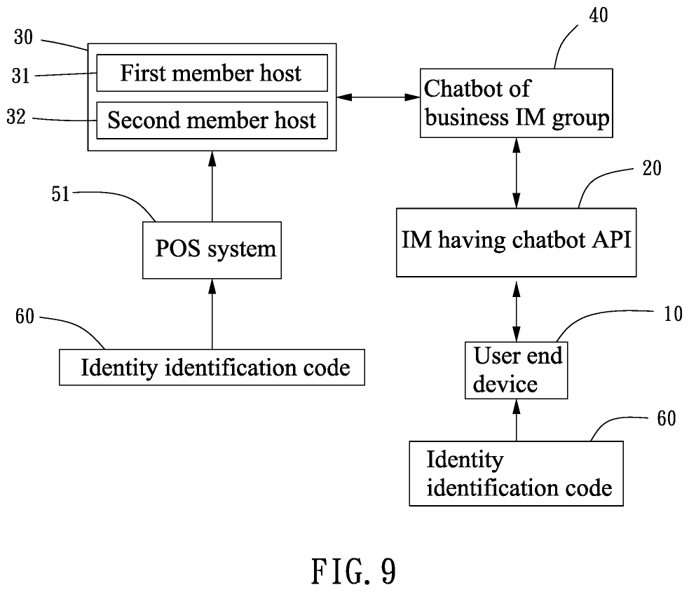

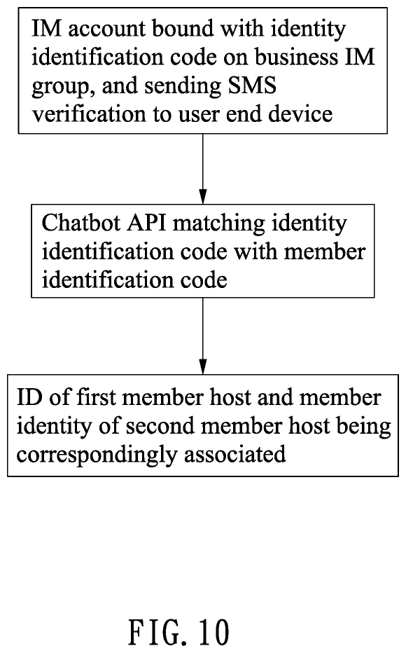

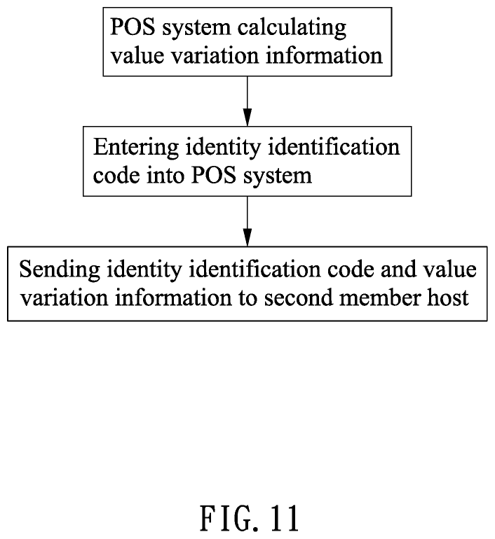

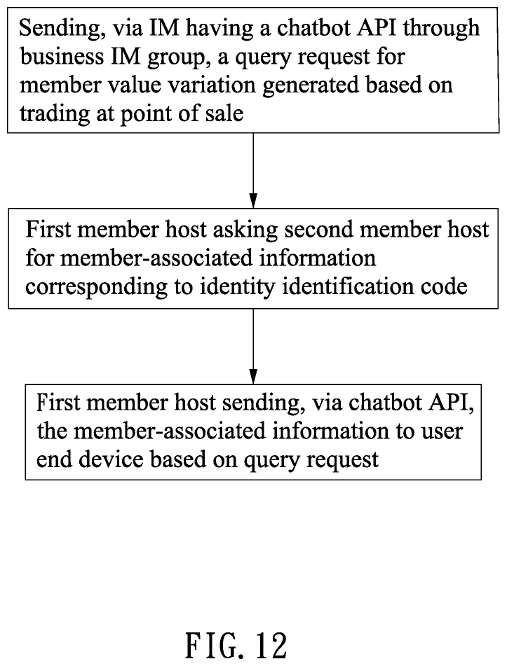

In a fourth preferred embodiment of FIGS. 9 to 12, the user end device 10 includes the information obtaining device, an identity identification code 60 (for example, a mobile phone number) is entered into the chatbot API 40 of the business IM group through the instant messenger 20 of the user end device 10 so that the IM account is bound with the identity identification code 60, the member host 30 includes a first member host (for example, a IM member host of a business) and a second member host (for example, a member credit host built by the business) which are communicable with each other, the first member host is in communication with the chatbot API 40, the second member host has at least one member identity, each said member identity includes a member identification code (for example, a mobile phone number), the chatbot API 40 matches the identity identification code 60 with the member identification code, a POS system 51 which is in communication with the second member host is used to calculate a value variation information based on an expense value, the identity identification code 60 is entered into the POS system 51, and the POS system 51 sends the identity identification code 60 and the value variation information to the second member host for recording and updating the member value. Thereby, when trading in an offline physical store, an end user does not need to show the QR code on the user end device 10 (for example, a mobile phone) to inform the business of the identity identification code 60 (for example, a mobile phone number) and collect credits on the member credit host which is self-owned by the business. However, the ID of the user end device may also be obtained via the reader or capture device mentioned above. This mode is more suitable for large businesses which has a self-built member credit system and a POS system, but has no corresponding “member ID of self-built member credit system” and “member ID of online IM business account”.

In the fourth preferred embodiment mentioned above, the member value management method further includes following steps of: the user end device 10 sending, through the business IM group, a query request for checking the member-associated information, the chatbot API 40 of the business IM group asking the first member host, based on the query request, to check the member-associated information of the second member host which corresponds to the ID of the user end device 10, the member value which corresponds to the member-associated information being sent through the chatbot API 40 of the business IM group to the user end device 10, the member-associated information being a member value variation generated based on trading at the point of sale.

Given the above, in the present invention, the IM account of the end user is added into the business group, the chatbot API in the business IM group assigns a set of “unique identification (ID)” to the end user, the ID is generated when the end user agrees to join the business IM group and is unique and identifiable, and a person who uses the business IM group cannot track and use “personal information disclosed in the instant messenger” of the end user based on the ID, so there will be no concerns of infringing IM users' privacy. Since a personal ID is generated by the chatbot API code of the instant messenger, exclusive member information can be built to identify a trade counterpart and allow the consumers to quickly check his/her member-associated information, including the ID and the member value given or deducted by the business, via the chatbot API of the instant messenger. Therefore, it is easier to manage the member value during the trading process between the consumers and the physical store(s), and the offline consumers may be attracted by the member value increase to instantly become the online business IM group member of the business so that the offline consumers and the online IM members can be combined together. In addition, the related information of the present invention can be further used on sale operation analysis and to quickly build a stable customer base for ecommerce.

While we have shown and described various embodiments in accordance with the present invention, it should be clear to those skilled in the art that further embodiments may be made without departing from the scope of the present invention.

What is claimed is:

1. A member value management method, including following steps of:
through an instant messenger (IM) on a user end device, joining a business IM group with an IM account of the user end device;
a chatbot application programming interface (API) of the business IM group generating an identification (ID) which corresponds to the IM account, saving the ID to a member host, and assigning the ID to the user end device through the business IM group, each said ID generated by the chatbot API being exclusive and unique, the ID being different from the IM account;
an information obtaining device at a point of sale obtaining a member-associated information which includes the ID and sending the member-associated information to the member host, the member host managing a member value corresponding to the ID based on the member-associated information.

2. The member value management method of claim 1, wherein the IM includes Line, Facebook, WeChat or WhatsApp.

3. The member value management method of claim 1, wherein the ID is a 2D barcode generated based on a code.

4. The member value management method of claim 1, wherein the chatbot API of the business IM group generates a code based on the IM account and generates a 2D barcode based on the code to be the ID.

5. The member value management method of claim 1, wherein the information obtaining device includes a point of sale (POS) system which is in communication with the member host and a reader which is connected to the POS system, the member value management method further includes using the POS system to calculate a value variation information base on an expense value, using the reader to obtain the ID of the user end device, and the POS system matching the ID of the user end device with the value variation information and sending to the member host for recording and updating the member value.

6. The member value management method of claim 1, wherein the information obtaining device is a capture device which is communicable with the member host and has a video capturing feature, the member value management method further includes following steps of: using a POS system to calculate a value variation information based on an expense value and generate a value variation identification code based on the value variation information; using the capture device to read the value variation identification code and the ID of the user end device, the capture device matching the ID of the user end device with the value variation information which corresponds to the value variation identification code and sending to the member host for recording and updating the member value.

7. The member value management method of claim 1, wherein the information obtaining device is a capture device which is communicable with the member host and has a video capturing feature, the member value management method further includes following steps of: entering a value variation information on the capture device based on an expense value; using the capture device to read the ID of the user end device, the capture device matching the ID of the user end device with the value variation information and sending to the member host for recording and updating the member value.

8. The member value management method of claim 5, further including following steps of: the user end device sending, via the IM having a chatbot API through the business IM group, a query request for checking the member-associated information, the chatbot API of the business IM group sending the member-associated information to the user end device based on the query request, the member-associated information being a member value variation generated based on trading at the point of sale.

9. The member value management method of claim 6, further including following steps of: the user end device sending, via the IM having a chatbot API through the business IM group, a query request for checking the member-associated information, the chatbot API of the business IM group sending the member-associated information to the user end device based on the query request, the member-associated information being a member value variation generated based on trading at the point of sale.

10. The member value management method of claim 7, further including following steps of: the user end device sending, via the IM having a chatbot API through the business IM group, a query request for checking the member-associated information, the chatbot API of the business IM group sending the member-associated information to the user end device based on the query request, the member-associated information being a member value variation generated based on trading at the point of sale.

11. The member value management method of claim 1, wherein the user end device includes the information obtaining device, an identity identification code is entered into the chatbot API of the business IM group through the IM of the user end device so that the IM account is bound with the identity identification code, the member host includes a first member host and a second member host which are communicable with each other, the first member host is in communication with the chatbot API, the second member host has at least one member identity, each said member identity includes a member identification code, the chatbot API matches the identity identification code with the member identification code, a POS system which is in communication with the second member host is used to calculate a value variation information based on an expense value, the identity identification code is entered into the POS system, and the POS system sends the identity identification code and the value variation information to the second member host for recording and updating the member value.

12. The member value management method of claim 11, further including following steps of: the user end device sending, through the business IM group, a query request for checking the member-associated information; the chatbot API of the business IM group asking the first member host, based on the query request, to check the member-associated information of the second member host which corresponds to the ID of the user end device; the member value which corresponds to the member-associated information being sent through the chatbot API of the business IM group to the user end device, the member-associated information being a member value variation generated based on trading at the point of sale.
